(19) United States
(12) Patent Application Publication
(10) Pub. No.: US 2009/0263541 A1
(43) Pub. Date: Oct. 22, 2009

(54) METHOD OF PRODUCING COCOA MASS, AND CHOCOLATE AND OTHER COCOA CONTAINING PRODUCTS PRODUCED FROM THE COCOA MASS

(75) Inventors: Lars Munck, Lund (SE); Jorgen Martin Dohm Schou, Rodovre (DK); Jesper Madsen Wagner, Kalundborg (DK); Dorthe Kjaer Pedersen, Roskilde (DK); Annette Steen Salskov-Iversen, Birkerod (DK)

Correspondence Address: SEED INTELLECTUAL PROPERTY LAW GROUP PLLC, 701 FIFTH AVE, SUITE 5400, SEATTLE, WA, 98104, US

(73) Assignee: TOMS GRUPPEN A/S, Ballerup (DK)

(21) Appl. No.: 12/302,786

(22) PCT Filed: Jun. 2, 2006
(86) PCT No.: PCT/DK06/00310

§ 371 Date: Jun. 24, 2009

(51) Int. Cl. A23G 1/02; A23G 1/30

(52) U.S. Cl. 426/45; 426/631

(57) ABSTRACT

In a method of producing cocoa mass from nibs from cracked, fermented cocoa beans, nibs are used from which nibs parts of an undesired degree of fermentation have been sorted out, for example by analysis of the individual nibs pieces for fluorescence, preferably by irradiation with UV light at two different wavelengths, preferably of about 254 nm and about 366 nm with a cut-off filter at about 390 nm, the analytical results being the basis of any sorting out of separate nibs pieces, or by sorting of the cocoa beans before cracking by thickness, by density or by hardness. In this respect, the fluorescence detection method can be used for monitoring the separation.

The present invention relates to a method of producing cocoa mass from nibs from cracked, fermented cocoa beans.

The nibs are usually roasted and ground in connection with the production of cocoa mass, the roasting being made before and/or after the cocoa beans are cracked.

Immediately upon harvesting of ripe cocoa pods, or cacao pods, the cocoa (or cacao) beans are removed from the pods and subjected to fermentation. This makes the pulp ferment away in 3-6 days while biochemical breakdown of the inside of the cocoa beans takes place caused by fermentation products and increased temperature. Then the cocoa beans are dried.

In the trade cocoa are dealt within generally two types or varieties, which in the trade are called bulk cocoa and fine or flavour cocoa, respectively. The main type of cocoa is Forastero, which is a bulk cocoa and comprises i.a. the varieties Lower Amazon, also called Amelonado, and Upper Amazon, and hybrids of these two. Fine or flavour cocoas comprise i.a. a type called Criollo and a type called Trinitario.

The fermentation is vital for cocoa beans of the Forastero type to be usable for the production of tasty chocolates, the Forastero type having a high content of bitter-tasting and astringent polyphenols. The polyphenols are widely degraded during the fermentation, leaving the cocoa bean well-fermented its nib having a brown colour and a characteristic pleasant cocoa taste.

For fine or flavour cocoas—especially the Criollo variety—a prolonged fermentation is of no value as these cocoas contain smaller amounts of or have no polyphenols. Therefore, the present invention is especially aimed at bulk cocoa types as the Forastero type, but it should be noted that a number of factors such as the below correlation between density and degree of fermentation have also been observed by the inventors for other sorts of cocoa beans, for example fine or flavour cocoas such as Criollo.

For cocoa beans of the Forastero varieties to be serviceable for the production of chocolate and cocoa products, it would be preferable if all cocoa beans of a batch were well-fermented. This would allow easy deshelling of all the nibs and gives an appealingly pleasant taste to all the nibs after roasting.

However, fermentation of the cocoa beans is a process carried out in the producer countries under primitive conditions difficult to control, the result being that not all cocoa beans are uniformly fermented. This is shown by the fact that a random lot of cocoa beans exhibit all degrees of fermentation on a sliding scale from unfermented to well-fermented. The fermentation is usually carried out either by heaping the fresh beans in a pile or by filling the fresh beans in a wooden box, which is an improvement of the heap method. However it is generally preferred not to have more than 80% of a batch well-fermented due the risk of having some of the beans in the batch over-fermented, which gives unwanted off-flavours.

A look at the intact cocoa bean in ordinary white light does not reveal any external visible differences between the various degrees of fermentation; but when the cocoa beans are cut through, it is possible by looking at the cut to assess the degree of fermentation by its colour as follows: the nibs of an unfermented bean has a slaty colour, the nibs of a partially fermented bean has a marked violet colour, while the nibs of a well-fermented bean is characterized by a pure brown colour.

Herein the terms slaty, violet and brown cocoa beans a used to designate cocoa beans with slaty, violet and brown nibs, respectively, and the terms slaty, violet and brown fermentation degree are used to designate, from low to high degree, the degree of unfermented, the degree of incompletely fermented and the degree of well-fermented, respectively.

In international trade an acceptable quality in practice contain a percentage—2-5%—of unfermented, slaty cocoa beans, and a considerable proportion—5-50%—of incompletely fermented, violet cocoa beans. In the trade the degree of fermentation is tested by the so-called cut test (ISO 1114, 2292 and 2451). In this test, after cutting through a representative number of cocoa beans, the number of slaty cocoa beans and the number of defective, worm-eaten or mouldy cocoa beans are counted. Specialists attribute a negative value to the incompletely fermented, violet form although it is not regarded in official trade.

From SU-A-646 254 it is known to determine the degree of fermentation for cocoa beans by estimating the ratio between certain coloured substances in the beans. This is done by treating the cocoa beans with a 97:3 mixture of MeOH and HCl at 5-10° C. for 20-24 hours. The optical density of the resulting extract at 460 nm and 530 nm is determined, and the ratio of the measurements is taken to express the degree of fermentation.

From SU-A-1 613 951 it is known to determine the degree of fermentation for a sample of cocoa beans by mixing the cocoa beans with EtOH in the ratio of 1:5 and extracting for 10-15 minutes. The extract is cooled to the boiling point of liquid nitrogen and illuminated at wavelengths of 360 and 380 nm. The luminescence at 460-470 nm and 580-590 nm is measured, and the ratio of these measurements is taken as a measure of the degree of fermentation.

From SU-A-1 386 897 it is known to determine the quality of a sample of cocoa beans, quality meaning the shell proportion of cocoa beans.

EP-A-0 227 027 describes an apparatus for sorting natural bulk cargo such as grains or seeds, e.g. cocoa beans, by size. The purpose of this sorting by size does not appear from the description.

GB-A-2 180 060 describes an apparatus for sorting agricultural products such as coffee beans, peanuts or beans into an acceptable and an unacceptable category by the colour of the individual objects of the product as it passes a chute or conduit. Since there are no visible differences between the various degrees of fermentation when looking at the intact cocoa beans in ordinary white light, the apparatus described in GB-A-2 180 060 cannot directly be used for sorting cocoa beans or nibs.

Finally, it is known from SU-A-695 646 to soak cocoa beans in water for 15-45 minutes to facilitate the subsequent removal of the shell parts of the beans.

It is thus a problem in the production of cocoa mass, especially of high quality, that a given batch of cocoa beans must be evaluated and possibly must be rejected as base material for high quality chocolate. A batch thus rejected may be used for the production of chocolate of a lower quality or for extraction of cocoa butter.

It is an object of the present invention to overcome this problem.

It is a further object of the present invention to provide a method for making cocoa mass, chocolate and other cocoa containing products produced or derived from the cocoa mass having an enhanced quality of taste.

A further object of the invention is to reduce the amount of incompletely fermented cocoa beans markedly in a given normally acceptable lot of cocoa beans for the production of chocolate.

Thus according to the invention a method of the type mentioned in the introduction is characterized in the use of nibs for the production of cocoa mass, nib parts of a lower degree of fermentation having been sorted out, the sorting being based on the fermentation degrees slaty, violet and brown. This makes it possible to improve the quality of the nibs of a given batch of cocoa beans in the sense of the ratio between the contents of slaty, violet and brown nibs in the batch.

The invention provides several different methods of sorting out cocoa beans and/or nibs of lower or undesired degrees of fermentation with a view to producing cocoa mass especially suitable for the production of fine-flavour chocolate.

In one embodiment, the cocoa beans are sorted by density before the cracking, whereby cocoa beans of undesired, preferably high, densities are sorted out, as cocoa beans of such densities generally have an undesired degree of fermentation in the inventors' experience. The cocoa beans may, for example, be floated in a liquid of a predetermined density, preferably water, possibly with salt, sugar and/or alcohol added to adjust the density. It is also possible mechanically to sort the cocoa beans by density, for example on an inclined shaking table with air ventilation, i.e. a so-called Gravity Separator.

Especially cocoa beans having a density above a predetermined value are sorted out, said predetermined value being e.g. 1.0×10³ kg m⁻³ or 0.9×10³ kg m⁻³.

In another embodiment, the cocoa beans are cracked by application of a predetermined force, particularly strokes or pressure, and uncracked cocoa beans are sorted out, as such uncracked cocoa beans generally have an undesired degree of fermentation in the inventors' experience. The cocoa beans may be cracked at a force of 40-80 N, preferably 40-60 N, measured across the width of the cocoa bean. Thereby substantially only the brown cocoa beans are cracked, and mainly all the slaty and violet cocoa beans are left uncracked. The cocoa beans may thereby e.g. be cracked between rollers of be cracked by being flung against a wall, as it is customary done, only the beans should be flung with a limited speed.

In a third embodiment, the cocoa beans are sorted by thickness, as sorting out of the relatively flat cocoa beans results in higher concentration of the relatively light and thus better fermented cocoa beans. In this connection it should be noted that cocoa beans has an oblong shape with an elliptic cross section. Thus a cocoa bean has a length, a width and a thickness the dimensions of thickness being the smallest of the three. By selection of thickness limits, the quantity and quality of the retained cocoa beans can be adapted as desired. In combination with sorting by density or breaking strength it is generally an advantage first to sort out the particularly flat cocoa beans as these mainly consist of mainly empty shells and can only be cracked with difficulty, for which reason in conventional methods they frequently recur in the nibs as undesired shell parts.

In a fourth embodiment, nibs parts of an undesired degree of fermentation are sorted out after the cracking, the individual nib pieces being analysed for fluorescence and the analytical results being the basis of any sorting out of separate nib pieces. More specifically, this can be carried out by irradiating the nibs with UV light at two different wavelengths, preferably of about 254 nm and about 366 nm, and detecting the resulting fluorescence in the visible area after passage of fluorescent light through a cut-off filter which only permits passage of light of a longer wavelength than the excitation wavelength. This would distinguish nib parts of different degrees of fermentation, as slaty, violet and brown nib parts exhibit different fluorescence properties, respectively, as will be explained in further detail below.

Due to the lack of specificity of the visual cut test, it is difficult or impossible to sort nibs optically by means of a photometer in the visible area.

These four embodiments can be used alternatively as needed or in any combination to supplement each other for obtaining the desired degree of concentration of nibs of a given preferred degree of fermentation.

According to a further method, the quality of the nibs is monitored by analysis of fluorescence by irradiation with UV light for the purpose of quality assessment of the purchased cocoa beans and/or control of the sorting.

The invention also relates to chocolate and other cocoa-containing products produced from cocoa mass derived according to the invention.

A cocoa product, such as chocolate, produced from bulk cocoa in accordance with the invention will exhibit measurable characteristics.

The invention described herein is based on the inventors observations and findings of a number of correlations between the fermentation status and physico-chemical and spectroscopic properties (ultraviolet (UV) and fluorescence, visual) of cocoa beans.

The first observation was that cut, slaty (unfermented) cocoa beans of the Forastero type fluoresce in UV light both at irradiation with 254 nm and 366 nm whereas the violet (incompletely fermented) cocoa beans only fluoresce at irradiation with 366 nm. The brown (well-fermented) beans do not fluoresce in UV light at the said wavelengths. Moreover, by observation of the cut cocoa beans in UV light, it is possible to identify “sub-classes” of the traditional fermentation groups (slaty-violet-brown) and thus describe the fermenting heterogeneity better.

At 366 nm, cut cocoa beans of the Criollo variety exhibit an undifferentiated yellow-brown fluorescence not relatable at present to the degree of fermentation.

The inventors further observed that at floatation in aqueous media of different densities, cocoa beans could be separated into density classes. On examining these density classes it was found that the lower the density of the cocoa beans, the bigger the likelihood of a high degree of fermentation of the cocoa bean.

### EXAMPLE 1

The below table 1 illustrates the outcome of an experiment of the inventors of separating cocoa beans by density ρ (g/ml) by floatation in liquids of different densities. Table 1 shows on one hand the correlation between the result of the cut test assessed at visible light (vis.) (as normally prescribed) and at UV light (UV) at the wavelengths 254 nm and 366 nm, and on the other hand the fermentation status in relation to density class.

TABLE 1

| | ρ > 1.1 | | 1.1 > ρ > 1.0 | | 1.0 > ρ > 0.9 | | 0.9 > ρ > 0.8 | | 0.8 > ρ | | Sum | |
|---|---|---|---|---|---|---|---|---|---|---|---|---|
| Density | Vis. | UV | Vis. | UV | Vis. | UV | Vis. | UV | Vis. | UV | Vis. | UV |
| Number | 1 | 1 | 138 | 138 | 214 | 214 | 84 | 84 | 4 | 4 | 441 | 441 |
| Slaty % | 0.0 | 0.0 | 1.4 | 1.8 | 0.2 | 0.0 | 0.5 | 0.2 | 0.0 | 0.0 | 2.0 | 2.0 |
| Violet % | 0.0 | 0.0 | 22.0 | 24.3 | 7.5 | 10.0 | 0.5 | 1.1 | 0.0 | 0.0 | 29.9 | 35.4 |
| Brown % | 0.0 | 0.0 | 5.9 | 3.9 | 40.8 | 38.1 | 18.1 | 17.7 | 0.9 | 0.9 | 65.8 | 60.5 |
| Defective % | 0.2 | 0.2 | 0.2 | 0.2 | 0.0 | 0.0 | 0.0 | 0.0 | 0.0 | 0.0 | 0.5 | 0.5 |
| Other % | 0.0 | 0.0 | 1.8 | 1.1 | 0.0 | 0.5 | 0.0 | 0.0 | 0.0 | 0.0 | 1.8 | 1.6 |
| Sum of | 0.2 | 0.2 | 31.2 | 31.2 | 48.5 | 48.5 | 19.0 | 19.0 | 0.9 | 0.9 | 100 | 100 |
| percentages | | | | | | | | | | | | |

In a number of samples of cocoa beans of different origins a clear correlation has been found by the inventors between the degree or status of fermentation (=percentage of brown cocoa beans) and density, which led to the designing of the following simple—objective—test of the general degree of fermentation of a random sample of cocoa beans:

A number of 300 cocoa beans are counted off and poured into about 2 l of water (15-25° C.). The water is stirred so that all beans are wetted, and when the water is calm, the floating beans are removed by means of a perforated ladle. The number is determined and calculated as a percentage of the starting number. A good average fermentation will yield 60-70% “floaters”. An especially well-fermented cocoa bean sample may exhibit 75-85% while a poor lot may be as low as 30-40%.

This test cannot directly replace a cut test, which tells about the health of a cocoa bean sample, among other things. But the “floater” method can be used to check whether it is at all reasonable to perform a more time-consuming cut test.

The inventors have also observed that cocoa beans exhibit very different consistencies when they are cut for preparation of the cut test. This difference in consistency is further demonstrated by the inventors' observation that the crushing of cocoa beans that easily occurs during their transportation mainly concerns the best fermented cocoa beans.

### EXAMPLE 2

A further study showed a correlation between the thickness and the density of cocoa beans as illustrated by Table 2, in which column 1 indicates the thickness fractile of the cocoa beans, columns 2-6 show the density fraction portions percent within the individual thickness fractiles, column 7 indicates the size of the fractiles in percent of all, columns 8 and 9 indicate respective additions of the percentages from columns 2-3 and 4-6, and column 10 indicates the ratio between the percentages in the two latter columns.

By sorting out the relatively flat cocoa beans it is clearly possible to obtain an increase of the portion percent of the light fractions, which, according to the above observations, cf. table 1, are especially rich in well-fermented cocoa beans.

TABLE 2

| Fractile | ρ > 1.1 | 1.1 > ρ> 1.0 | 1.0 > ρ > 0.9 | 0.9 > ρ > 0.8 | ρ < 0.8 | Size | ρ < 1.0 | ρ > 1.0 | <1/>1 |
|---|---|---|---|---|---|---|---|---|---|
| All | 6.5% | 37.0% | 39.5% | 13.5% | 3.5% | 100.0% | 56.5% | 43.5% | 1.30 |
| >4.0 mm | 6.6% | 37.6% | 39.6% | 13.2% | 3.0% | 98.5% | 55.8% | 44.2% | 1.26 |
| >5.0 mm | 6.8% | 37.5% | 39.1% | 13.5% | 3.1% | 96.0% | 55.7% | 44.3% | 1.26 |
| >5.5 mm | 5.9% | 36.9% | 40.1% | 13.9% | 3.2% | 93.5% | 57.2% | 42.8% | 1.34 |
| >6.0 mm | 5.3% | 36.8% | 40.9% | 14.0% | 2.9% | 85.5% | 57.9% | 42.1% | 1.38 |
| >6.5 mm | 5.3% | 35.5% | 42.1% | 15.1% | 2.0% | 76.0% | 59.2% | 40.8% | 1.45 |
| >7.0 mm | 6.3% | 31.3% | 46.1% | 14.8% | 1.6% | 64.0% | 62.5% | 37.5% | 1.67 |
| >7.5 mm | 7.6% | 26.7% | 47.6% | 16.2% | 1.9% | 52.5% | 65.7% | 34.3% | 1.92 |
| >8.0 mm | 9.3% | 21.3% | 49.3% | 18.7% | 1.3% | 37.5% | 69.3% | 30.7% | 2.26 |
| >8.5 mm | 11.5% | 17.3% | 48.1% | 21.2% | 1.9% | 26.0% | 71.2% | 28.8% | 2.47 |
| >9.0 mm | 10.0% | 6.7% | 53.3% | 26.7% | 3.3% | 15.0% | 83.3% | 16.7% | 5.00 |
| >9.5 mm | 5.3% | 0.0% | 52.6% | 36.8% | 5.3% | 9.5% | 94.7% | 5.3% | 18.00 |
| >10.0 mm | 0.0% | 0.0% | 45.5% | 45.5% | 9.1% | 5.5% | 100.0% | 0.0% | — |

The invention will now be explained in more detail by means of examples of embodiments with reference to the accompanying drawings, without restriction the scope of the invention to said embodiments. In the drawings:

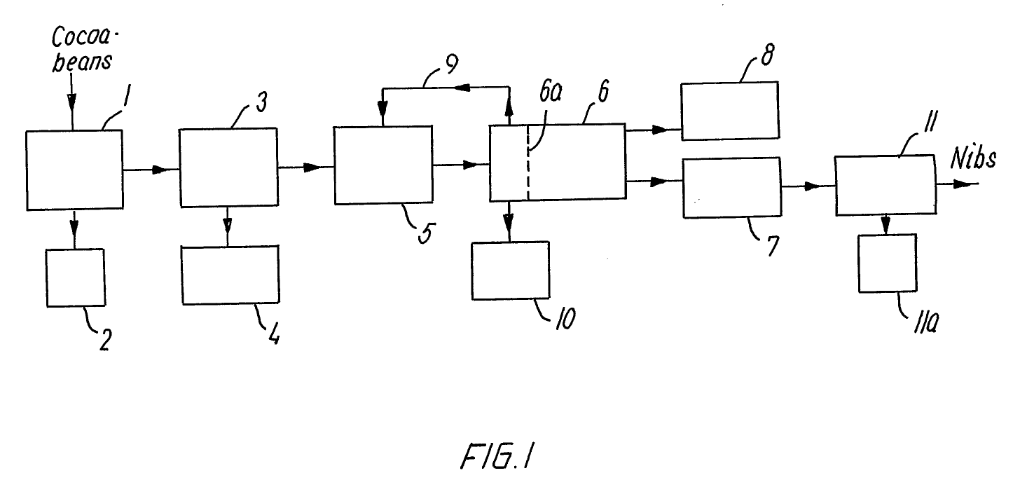

FIG. 1 shows schematically a process for separating shells and nibs,

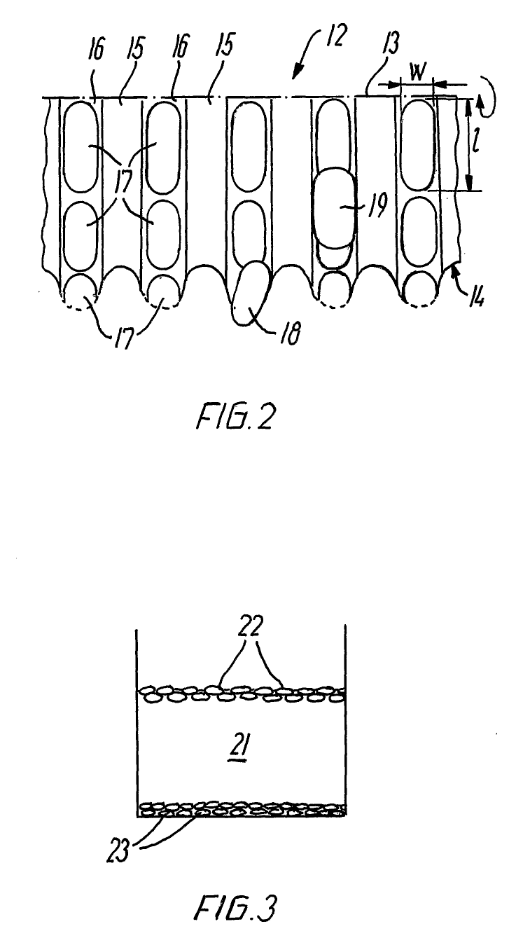

FIG. 2 illustrates a screen for performing a preferred method of the invention,

FIG. 3 illustrates the principle of floatation,

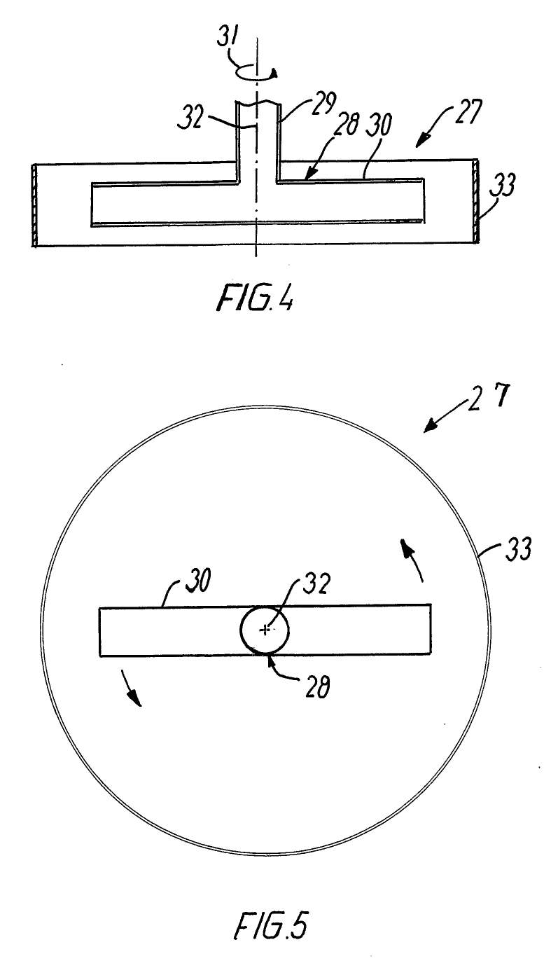

FIG. 4 illustrates a breaker in a vertical section, and

FIG. 5 shows the breaker of FIG. 4 seen from above.

The general process illustrated in FIG. 1 is as follows:

The cocoa beans are initially sifted through screens having circular holes to remove (reject) particles coarser than cocoa beans, such as pieces of wood, rope, bark etc. and particles finer than cocoa beans such as dust and dirt that is erroneously contained in the batch. Further the cocoa beans may pass a magnet to remove any iron scrap etc. and a remover for heavy particles of material such as glass and stone. This remover will remove particles having a density greater than e.g. 2 kg/I and thus no cocoa beans will be removed thereby. Apparatus 1 herefore are well-known in the art and are produced e.g. by Bühler A G, Switzerland. A reject 2 of this cleaning stage is removed as garbage.

After the initial sifting and removal of iron, glass, stones, etc. the thus cleaned cocoa beans may be roasted, or roasting may take place at a later stage. In the present example the roasting is carried out at a later stage after separation of the nibs and the shells of the cocoa beans and outside the scope of the present description.

The cleaned cocoa beans may according to the present invention pass a sorting step 3 in which the whole, i.e. uncracked, cocoa beans are subjected a sorting to sort out cocoa beans having a low degree of fermentation thus enhancing the concentration of well-fermented beans in the batch. This sorting may according to the invention be performed e.g. according to density or thickness. In a preferred embodiment a sorting is performed at this stage according to thickness of the cocoa beans as shall be explained in further detail below. A reject 4 of this sorting step may be used for other purpose e.g. production of lower quality chocolate or for pressing off cocoa butter.

After the optional sorting the cocoa beans are broken in a breaker 5, which may e.g. be a disk breaker or an impact crusher. Disk breakers are e.g. manufactured by Lehmann Maschinenfabrik GmbH, Germany and impact crushers are e.g. manufactured by Bühler A G, Switzerland.

The broken cocoa beans are treated in a winnowing apparatus 6, whereby the nibs 7 and the shell pieces 8 are separated. Apparatus 6 for the winnowing process are manufactured e.g. by Lehmann Maschinenfabrik GmbH, Germany and by Bühler A G, Switzerland. In the known winnowing processes particles exceeding a certain size are sorted out by sifting through a screen schematically indicated by 6a and are recirculated to the breaker 5 as indicated by arrow 9. According to the present invention the particles sorted out by the screen 6a may, instead of being recirculated, be removed from the process as reject 10 since these particles are mainly unbroken cocoa beans, which according to the discovery of the inventors are mainly cocoa beans of a low degree of fermentation. The breaker may according to the present invention be adjusted, e.g. by adjusting the rotation speed of the disk of a disk breaker, into breaking mainly only cocoa beans of a high degree of fermentation since these cocoa beans are relatively easily broken compared to the beans of a low degree of fermentation. The reject 10 may be used for other purpose e.g. production of lower quality chocolate or for pressing off cocoa butter.

After the winnowing step the nibs may according to the invention in a sorting step 11 be sorted according to fluorescence characteristics when illuminated by IR radiation at wavelength of e.g. 254 nm and/or 366 nm as described in more detail below. Reject 11a from the sorting step 11 may be used for other purpose e.g. production of lower quality chocolate or for pressing off cocoa butter.

In a preferred embodiment the sorting of the nib material is carried out by sorting the cocoa beans by thickness in a sorting step before the breaking of the cocoa beans as in the sorting step 3 of FIG. 1.

Sorting by thickness is preferably carried out by screening off cocoa beans thinner than 6.0 mm by means of a screen with slot-shaped openings (length (l): 20 mm, width (w): 6 mm). A screen with such holes is illustrated in FIG. 2, which shows a section of a drum sieve 12 having an axis of rotation 13. The drum sieve comprises a corrugated plate material 14 having, as seen from the inside of the drum, crests 15 and vales 16 extending in the circumferential direction with elongate holes or openings 17 extending circumferentially in the vales 16. A relative thin cocoa bean 18 is shown passing through one of the holes while a relative thick cocoa bean 19 is shown sliding down a vale. The corrugation tends to raise the cocoa beans to a position with their smallest dimension, i.e. their thickness, extending in the axial direction of the drum sieve 12 thus facilitating the passage of relative thin cocoa beans through the openings 17. Sloping the drum sieve 12 relative to horizontal will make a batch of cocoa beans in general pass through the drum sieve in the axial direction. By screening off cocoa beans having a thickness smaller than 6 mm, the proportion of cocoa beans lighter than 1.0 g/ml is increased e.g. from originally 56.5% to 57.9% and thus the ratio between light and heavy beans is increased from 1.30 to 1.38. This change especially reduces the amount of heavy, but empty cocoa beans that make a large shell contribution.

By using a width of the openings 17 of 9.0 mm or higher, the lightest (most well-fermented) cocoa beans may be isolated, thus obtaining a batch of cocoa beans having a concentration of approximately 90% brown or well-fermented cocoa beans. Other methods, such as sorting by fluorescence characteristics, may be more sophisticated and provide even a higher concentration, but from a cost-benefit view sorting by thickness is preferred.

In another embodiment the intact cocoa beans may be sorted prior to breaking by density by floatation or by means of a so-called Gravity Separator.

Sorting by floatation is illustrated in FIG. 3. Sorting by floatation may be carried out by submerging the cocoa beans in tap water 21 of ordinary room temperature (e.g. 20° C.). When the liquid is calm, the floating cocoa beans 22 are removed from the water and dried to proceed in the process indicated in FIG. 1. The cocoa beans 23 that have dropped to the bottom are rejected. The starting volume of cocoa beans may e.g. have a content of about 64% brown cocoa beans. The light, floating fraction, that may have constituted e.g. 69% of the starting volume, may exhibit e.g. 86% brown cocoa beans.

By carrying out the floatation in 50% iso-PrOH, the light, floating fraction may constitute e.g. 21% of the starting volume, and may exhibit a content of 96% brown cocoa beans.

Sorting on by means of a Gravity Separator (manufactures i.a. Westrup A/S, Denmark and Cimbria Heid GmbH, Germany) comprising a shaking, vented table (not shown) is carried out by adapting a flow rate of air through a table web, an inclination of the table and a feed rate of cocoa beans so that the cocoa beans spread evenly across the table. Along an edge of the table, collection openings are adjusted so as to obtain the preferred fractioning by degree of fermentation of the cocoa beans. In a typical run a fraction comprising 85-90% well-fermented cocoa beans can be obtained from an ordinary batch, said fraction constituting approximately 50% of the batch. The capacity of a Gravity Separator may be up to 4000 kg/hour.

Sorting by crushing at a limited force can be carried out in several manners, i.a. by passing the cocoa beans on a conveyor under hard rollers that exert an adapted pressure against the conveyor. Then the uncracked—mainly incompletely fermented—cocoa beans are screened off and shells are removed from the rest in any manner known per se.

Another method is to fling the cocoa beans against a wall at a controlled speed. This is in general a method known per se and it is the method used e.g. by the disk breaker manufactured by Lehmann Maschinenfabrik GmbH, which is referred to in FIG. 1, reference numeral 5. However in the known processes the crushing is carried out with the intent of crushing all cocoa beans in a batch.

For the sake of illustrating the method of crushing or breaking by limited force reference is made to FIGS. 4 and 5. A breaker 27 comprises a T-shaped tube 28 having a leg 29 and a transverse 30. The T-shaped tube 28 is rotating as indicated by arrow 31 around a longitudinal axis 32 of the leg 29, said axis 32 being a symmetry axis of the T-shaped tube 28. The traverse 30 is thereby rotating inside an annular wall 33. When cocoa beans are passed down the leg 29 they will be accelerated by the traverse 30, when passing through it, and be flung against the inner side of the annular wall 33 to be crushed by the impact against the wall 33. By adjusting the rotational speed of the T-shaped tube 28, the force by which the cocoa beans hit the annular wall 33 can be adapted so that only the most brittle (well-fermented) cocoa beans are crushed. The uncracked cocoa beans are screened off, and the shells are removed from the rest (the nibs) in any manner known per se, cf. reference numerals 6, 6a, 7, 8, and 10 of FIG. 1 and the accompanying description.

Sorting of nibs on the basis of fluorescence can be carried out by means of the apparatus described in GB-A-2 180 060, the flowing nibs being irradiated with UV light at a wavelength of e.g. 366 nm while detection for fluorescence in visible light is carried out with a suitable cut-off filter. If the apparatus is excited by fluorescence, the nib particle in question is removed from the flow. By passing the nibs through several consecutive detector devices having respective excitation wavelengths, such as 254 nm and 366 nm, it is possible to obtain a division of the nibs into several fermentation groups. The method is thus considerably more specific than sorting by colour in visible light would be.

The skilled person will appreciate that all the methods of sorting out cocoa beans according to the invention and disclosed herein are applicable in automatic or machine sorting of cocoa beans.

The efficiency of the above methods (other than sorting by thickness) is considerably improved if a prior sorting by thickness has been carried out, eliminating “flat” cocoa beans, typically of a thickness less than 6.0 mm.

Monitoring of the sorting process applied to either cocoa beans or nibs is advantageously carried out by exploiting the described difference in fluorescence of the different degrees of fermentation. This may be done by eye or automatically, for example with a CCD camera with suitable filters, or photometrically, preferably in the visible area, for example with a cut-off filter at about 390 nm.

Due to the different fluorescence characteristics of cocoa nibs of different degree of fermentation it will be possible to detect chocolate products made by the process according to the invention, such products having an extraordinary lack of constituents with a low degree of fermentation and shell parts and an extraordinary high percentage of well-fermented (brown) nibs constituents.

1.-13. (canceled)

14. A method of producing cocoa mass from nibs from cracked, fermented cocoa beans, said method comprising the step of sorting out from a batch of cocoa beans nibs parts of a certain degree of fermentation and using for the production of cocoa mass the nibs from which nibs parts of a certain degree of fermentation have been sorted out.

15. A method according to claim 14, whereby nibs parts of a low degree of fermentation are sorted out.

16. A method according to claim 14, wherein the step of sorting out comprises sorting the cocoa beans by density before cracking, whereby cocoa beans of certain densities are sorted out.

17. A method according to claim 16, wherein cocoa beans having a density above a predetermined value, preferably above 1.0 kg per liter, more preferably above 0.9 kg per liter, are sorted out.

18. A method according to claim 16, wherein the cocoa beans are floated in a liquid of a predetermined density, preferably water, possibly with salt, sugar and/or alcohol added to adjust the density.

19. A method according to claim 16, wherein the cocoa beans are sorted mechanically, preferably on an inclined shaking table with air ventilation.

20. A method according to claim 14, wherein the step of sorting out comprises cracking the cocoa beans by application of a predetermined force and sorting out uncracked cocoa beans.

21. A method according to claim 20, wherein the cocoa beans are cracked by a force of 40-80 N, preferably 40-60 N.

22. A method according to claim 14, wherein the step of sorting out comprises sorting the cocoa beans by thickness before the cracking, whereby cocoa beans of certain thicknesses are sorted out.

23. A method according to claim 22, wherein cocoa beans having a thickness below a predetermined value, preferably below 6 mm, more preferably below 9-9,5 mm, are sorted out.

24. A method according to claim 14, wherein a step of sorting out comprises analysing after the cracking individual nibs pieces for fluorescence and sorting out individual nibs pieces on basis of the analytical results.

25. A method according to claim 24, wherein the nibs pieces are irradiated with UV light at two different wavelengths, preferably of about 254 nm and about 366 nm, and that the resulting fluorescence is detected, preferably by eye, with a CCD camera or with a photometer, preferably in the visible area, for example with a cut-off filter at about 390 nm.

26. A method according to claim 14, wherein the quality of the cocoa beans and the nibs derived by the method is monitored by analysis of fluorescence at irradiation with UV light for the purpose of control and/or quality assessment of the sorting.

27. A cocoa-containing product, especially chocolate, produced or derived from cocoa mass produced according to claim 14.

28. The use of nibs of a batch of cocoa beans from which nibs parts of a certain degree of fermentation have been sorted out in a method of producing cocoa mass from nibs from cracked, fermented cocoa beans.
